(19) United States
(12) Patent Application Publication
(10) Pub. No.: US 2024/0157693 A1
(43) Pub. Date: May 16, 2024

(54) Providing A Z Fiber Composite Component

(71) Applicant: Textron Systems Corporation, Hunt Valley, MD (US)

(72) Inventor: Michael Robert FAVALORO, Amesbury, MA (US)

(21) Appl. No.: 18/211,646

(22) Filed: Jun. 20, 2023

Related U.S. Application Data
(60) Provisional application No. 63/389,460, filed on Jul. 15, 2022.

(51) Int. Cl. B32B 37/18; B32B 5/12; B32B 37/00; B32B 37/10

(52) U.S. Cl. CPC B32B 37/18; B32B 5/12; B32B 37/025; B32B 37/10; B32B 2262/106; B32B 2305/10; B32B 2307/306; B32B 2313/04; B32B 2605/18

(57) ABSTRACT

Techniques for providing a carbon composite component involve providing a first carbon composite layer having carbon fibers extending along the first carbon composite layer. The techniques further involve providing a second carbon composite layer in contact with the first carbon composite layer, the second carbon composite layer having upright carbon fibers. The techniques further involve providing a third carbon composite layer in contact with the second carbon composite layer, the third carbon composite layer having carbon fibers extending along the third carbon composite layer. The carbon composite layer having upright carbon fibers increases the interlaminar strength of the resulting structure thus providing strength in all dimensions/directions and alleviating the need for additional fasteners and/or 3D carbon/carbon.

### BACKGROUND

Some aerospace applications use ablative composites for heat shielding. During ablation, material is lost (or sacrificed) while dissipating large amounts of heat.

A conventional way to construct an ablative composite is to wrap tape over a mandrel having the shape of an object to be heat shielded. Along these lines, the tape is wrapped onto itself again and again to build up the composite. After the formed composite cures and is removed from the mandrel, the formed composite has the shape of the object. For example, a cylinder can be continuously tape wrapped with a carbon-phenolic tape (e.g., a tape containing carbon fibers impregnated with phenolic resin) in a shingled approach to create a cylindrically-shaped ablative composite.

### SUMMARY

Unfortunately, there are deficiencies to the above-described conventional tape wrapping process. For example, if the tape that is used to create the composite is 2D carbon/carbon (where carbon fibers extend within the plane of the tape), the interlaminar strength will be relatively weak. That is, 2D carbon/carbon tape typically exhibits poor chemical and mechanical bonding between tape layers thus leaving the composite vulnerable to undesired delamination unless additional fasteners are added.

In place of 2D carbon/carbon, one might consider using 3D carbon/carbon in which the above-described 2D carbon/carbon phenolic incorporates additional carbon through the thickness of the 2D fabric plies. However, 3D carbon/carbon is more complex and expensive to make. Moreover, quality 3D carbon/carbon may be extremely difficult to supply.

In contrast to the above-described conventional tape wrapping process which involves wrapping tape onto itself again and again to build up an ablative composite, improved techniques involve providing a structure that includes a carbon composite layer having upright carbon fibers (e.g., herein referred to as “Z fibers”) between other carbon composite layers having carbon fibers extending along the other carbon composite layers (e.g., layers with enhanced XY properties). Using a carbon composite layer having upright carbon fibers increases the interlaminar strength of the resulting structure. Accordingly, such a structure enjoys Z reinforcement and strength in all dimensions. As a result, there is no need to use additional fasteners or 3D carbon/carbon.

One embodiment is directed to a method of providing a carbon composite component. The method includes providing a first carbon composite layer having carbon fibers extending along the first carbon composite layer (e.g., a layer of 2D carbon/carbon). The method further includes providing a second carbon composite layer in contact with the first carbon composite layer, the second carbon composite layer having upright carbon fibers (e.g., a layer of Z fibers). The method further includes providing a third carbon composite layer in contact with the second carbon composite layer, the third carbon composite layer having carbon fibers extending along the third carbon composite layer (e.g., a layer of 2D carbon/carbon).

Another embodiment is directed to a heat resistant structure formed at least in part by the method. Here, the second carbon composite layer may serve as low cost 3D reinforcement between the first and third carbon composite layers.

Yet another embodiment is directed to an apparatus to provide a carbon composite component. The apparatus includes a set of carbon composite material sources, a base, and layering equipment. The layering equipment is constructed and arranged to perform a method of:
(A) providing, from the set of carbon composite material sources on to the base, a first carbon composite layer having carbon fibers extending along the first carbon composite layer,
(B) providing, from the set of carbon composite material sources, a second carbon composite layer in contact with the first carbon composite layer, the second carbon composite layer having upright carbon fibers (e.g., perpendicular to prior 2D layers), and
(C) providing, from the set of carbon composite material sources, a third carbon composite layer in contact with the second carbon composite layer, the third carbon composite layer having carbon fibers extending along the third carbon composite layer.

In some arrangements, providing the first carbon composite layer includes depositing, as the first carbon composite layer, a planar prepreg layer having a carbon matrix with an embedded carbon fiber pattern parallel to surfaces of the planar prepreg layer. Additionally, the second carbon composite layer includes, as the upright carbon fibers, milled carbon fiber segments. Furthermore, providing the second carbon composite layer includes placing the second carbon composite layer onto the planar prepreg layer to orient the milled carbon fiber segments in a direction that is toward a surface of the planar prepreg layer.

In some arrangements, placing the second carbon composite layer onto the planar prepreg layer includes applying pressure to press the second carbon composite layer and the planar prepreg layer together to point filament ends of the milled carbon fiber segments of the second carbon composite layer into the planar prepreg layer.

In some arrangements, providing the third carbon composite layer includes placing, as the third carbon composite layer, another planar prepreg layer having a carbon matrix with an embedded carbon fiber pattern parallel to surfaces of the other planar prepreg layer.

In some arrangements, placing the other planar prepreg layer includes applying pressure to press the other planar prepreg layer and the second carbon composite layer together to point other filament ends of the milled carbon fiber segments of the second carbon composite layer into the other planar prepreg layer.

In some arrangements, providing the second carbon composite layer further includes removing a carrier film (or skin) from the second carbon composite layer. The film is arranged to maintain integrity of the second carbon composite layer prior to the second carbon composite layer being placed onto the planar prepreg layer.

In some arrangements, removing the film from the second carbon composite layer includes peeling the film from the second carbon composite layer to expose a planar side of the second carbon composite layer.

In some arrangements, the second carbon composite layer and the film form a Z fiber tape. Additionally, providing the second carbon composite layer further includes unrolling the Z fiber tape from a spool as the second carbon composite layer is placed onto the planar prepreg layer.

In some arrangements, the method further includes depositing, in alternation over the third carbon composite layer, (i) additional planar prepreg layers, each additional planar prepreg layer having a carbon matrix with an embedded carbon fiber pattern parallel to surfaces of that additional planar prepreg layer and (ii) additional carbon composite layers including upright carbon fiber segments to build a heat resistant structure.

It should be understood that the method may involve additional processing such as curing, compression or autoclave molding, and/or other fabricating activities. In some arrangements, the method further includes forming the heat resistant structure into a heatshield for hypersonic flight. In some arrangements, the method further includes forming the heat resistant structure into a brake pad. In some arrangements, the method further includes forming the heat resistant structure into a nozzle cover for a nozzle. Other components, shapes, objects, etc. are suitable for use as well.

Other embodiments are directed to apparatus, devices, and related componentry. Some embodiments are directed to various vehicles, equipment, tools, systems, sub-systems, methods, and so on, which involve providing a Z fiber composite component.

This Summary is provided merely for purposes of summarizing some example embodiments so as to provide a basic understanding of some aspects of the disclosure. Accordingly, it will be appreciated that the above described example embodiments are merely examples and should not be construed to narrow the scope or spirit of the disclosure in any way. Other embodiments, aspects, and advantages will become apparent from the following detailed description taken in conjunction with the accompanying drawings which illustrate, by way of example, the principles of the described embodiments.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a diagram of an environment for providing a Z fiber composite component in accordance with certain embodiments.

FIG. 2 is a top view of a first carbon composite layer in accordance with certain embodiments.

FIG. 3 is a top view of a second carbon composite layer in accordance with certain embodiments.

FIG. 4 is a cross-sectional view of a Z fiber composite component in accordance with certain embodiments.

FIG. 5 is a perspective view of certain equipment in accordance with certain embodiments.

FIG. 6 is a cross-sectional view of at least a portion of another Z fiber composite component in accordance with certain embodiments.

FIG. 7 is a flowchart of a procedure for providing a Z fiber composite component in accordance with certain embodiments.

### DETAILED DESCRIPTION

An improved technique involves providing a structure that includes a carbon composite layer having upright carbon fibers (or “Z fibers”) between other carbon composite layers having carbon fibers extending along the other carbon composite layers (e.g., layers with enhanced XY properties). Using a carbon composite layer having upright carbon fibers (e.g., a thin Z reinforcement film) increases the interlaminar strength of the resulting structure. Accordingly, such a structure enjoys Z reinforcement and strength in all dimensions. Thus, there is no need to use additional fasteners or to use 3D carbon/carbon.

The various individual features of the particular arrangements, configurations, and embodiments disclosed herein can be combined in any desired manner that makes technological sense. Additionally, such features are hereby combined in this manner to form all possible combinations, variants and permutations except to the extent that such combinations, variants and/or permutations have been expressly excluded or are impractical. Support for such combinations, variants and permutations is considered to exist in this document.

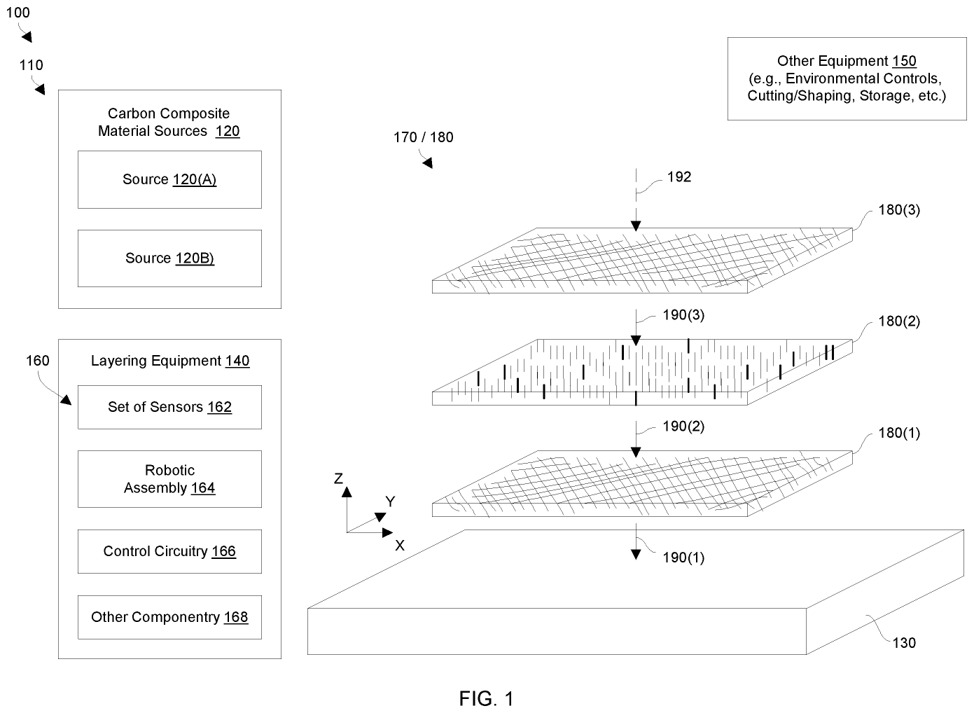

FIG. 1 is a diagram of an environment 100 for providing a Z fiber composite component in accordance with certain embodiments. The environment 100 includes an apparatus 110 which is constructed and arranged to provide the Z fiber composite component from carbon composite layers having different carbon fiber arrangements (e.g., different carbon fiber patterns). The apparatus 110 includes a set of carbon composite material sources 120, a base 130, layering (or handling) equipment 140, and other equipment 150.

The set of carbon composite material sources 120 includes different carbon composite layer sources 120(A) and 120(B). The carbon composite layer source 120(A) is constructed and arranged to supply a carbon composite layer having carbon fibers extending along the carbon composite layer (e.g., elongated carbon fibers within the plane of the layer). The carbon composite layer source 120(B) is constructed and arranged to supply a carbon composite layer having upright carbon fibers (e.g., short carbon fiber segments extending across the plane of the layer).

The base 130 is constructed and arranged to provide a surface or foundation upon which the structure of a Z fiber composite component may be built. As will be explained in further detail shortly, the Z fiber composite component may be constructed by deploying, in alternation, the different carbon composite layers from the carbon composite material sources 120(A), 120(B) to build up the structure.

Along these lines, the base 130 may provide a flat surface, a curved surface, an irregular surface, combinations thereof, and so on. In some arrangements, the base 130 may be a template form (e.g., a reusable mold, model, mandrel, master, etc.) having the shape (or contour) of an object (or a portion of the object) to eventually be protected by the carbon composite. In other arrangements, the base 130 may the object itself.

The layering (or handling) equipment 140 is constructed and arranged to manage deployment of the carbon composite layers from the carbon composite material sources 120 to provide the Z fiber composite component. Along these lines, the layering equipment 140 includes components 160 such as a set of sensors 162, a robotic assembly 164, control circuitry 166, and other componentry 168. The set of sensors 162 enables the layering equipment 140 to monitor environmental conditions such as temperature, humidity, time, available/remaining supply of the carbon composite materials from the sources 120, positions of the carbon composite materials during deployment, pressure, irregularities/anomalies, and so on. The robotic assembly 164 handles carbon composite material unloading (e.g., unrolling) of the carbon composite materials from the sources 120, precision placement/alignment of the carbon composite materials relative to the base 130 and/or earlier placed/aligned layers, compression, layer cutting, and so on. The control circuitry 166 controls operation of the robotic assembly 164 based on input (e.g., feedback, predefined movements, etc.) from the set of sensors 162 to ensure that execution of the process is correct and consistent. The other componentry 168 represents other layering componentry/elements/etc. such as a set of specialized heads for delivering the carbon composite materials onto the base 130 and then on top of each other, tools for applying heat/cooling/air/etc. to prepare each layer for further processing, record keeping, etc.

The other equipment 150 of the environment 100 represents additional environmental resources/mechanisms. For example, the other equipment 150 may include environmental sensors/controls, tools for shaping and cutting the carbon composite structure after the initial carbon composite structure is created, other processing equipment, storage for the carbon composite structure, combinations thereof, and so on.

During operation and in accordance with certain embodiments, the layering equipment 140 provides carbon composite materials from the sources 120 to form a Z fiber composite component 170. All or parts of such operation may be initiated by a set of commands, and then partially or fully automated.

In some arrangements, one or more of the carbon composite material sources stores the carbon composite material on a spool (e.g., as a tape or a sheet) to supply the carbon composite material as a layer when unwound from the spool by the layering equipment 140. When carbon composite material is supplied from a spool, the layering equipment 140 may include a set of cutters to cut the carbon composite material to finish that carbon composite material layer.

Initially, the base 130 is open and ready to receive a first layer of the carbon composite material (e.g., a layer of carbon/phenolic prepreg with predominant XY fiber volume). By way of example and as shown in FIG. 1, the base 130 provides a flat/planar surface that extends in the X and Y directions.

For a first layer, the layering equipment 140 unwinds, stretches, and lays a carbon composite material layer 180(1) from the carbon composite material source 120(A) onto the base 130. As shown in FIG. 1, the carbon composite material layer 180(1) is parallel to the X-Y plane and has embedded carbon fibers extending along the X-Y plane. The act of placing the carbon composite material layer 180(1) onto the base 130 is illustrated by the arrow 190(1) and can be accomplished in a variety of ways such as using a set of applicators (e.g., one or more heads, rollers, presses, plates, actuators, motors, other robotics, combinations thereof, etc.). Moreover, it should be understood that the set of applicators and/or the base 130 may be moved to effectuate deployment.

For the second layer, in a manner similar to that for the carbon composite material layer 180(1), the layering equipment 140 delivers a carbon composite material layer 180(2) from the carbon composite material source 120(B) onto the carbon composite material layer 180(1). As shown in FIG. 1, the carbon composite material layer 180(2) is parallel to the X-Y plane and has upright carbon fibers extending in the Z direction. In some arrangements, the carbon composite material layer 180(2) takes the form of a thin Z reinforcement film. The act of placing the carbon composite material layer 180(2) onto the carbon composite material layer 180(1) is illustrated by the arrow 190(2).

In accordance with certain embodiments, when the carbon composite material is supplied from a spool, the carbon composite material for the carbon composite material layer 180(2) is initially supported by a removable film (or wrapper) to prevent the carbon composite material from separating (or losing integrity) prior to placement due to X-Y direction weakness. For example, the carbon composite material may be supplied in combination with the removable film to form a spooled Z tape. As the layering equipment 140 unwinds the Z tape from the spool and onto the carbon composite material layer 180(1), the layering equipment 140 peels off the removable film to expose a top surface of the carbon composite material layer 180(2). Accordingly, the carbon composite material layer 180(2) is properly placed in contact with the carbon composite material layer 180(1), and the carbon composite material layer 180(2) is ready to receive another carbon composite layer.

In some arrangements, the layering equipment 140 applies a predefined amount of downward pressure to embed ends of the upright carbon fibers of the carbon composite material layer 180(2) into the carbon composite material layer 180(1). Accordingly, chemical and/or mechanical bonding between the carbon composite material layers 180(1), 180(2) is strengthened.

Next, the layering equipment 140 unwinds, stretches, and lays a carbon composite material layer 180(3) from the carbon composite material source 120(A) onto the carbon composite material layer 180(2). As shown in FIG. 1, the carbon composite material layer 180(3) is parallel to the X-Y plane and has embedded carbon fibers extending along the X-Y plane. The act of placing the carbon composite material layer 180(3) onto the carbon composite material layer 180(2) is illustrated by the arrow 190(3) and can be accomplished in a variety of ways such as using a set of applicators as explained earlier for the layer 180(1).

In some arrangements, the layering equipment 140 applies a predefined amount of downward pressure to embed ends of the upright carbon fibers of the carbon composite material layer 180(2) into the carbon composite material layer 180(3). As a result, chemical and mechanical bonding between the carbon composite material layers 180(2), 180(3) is enhanced.

Moreover, as each layer 180 is provided, it should be understood that the layering equipment 140 and the other equipment 150 operate to optimize construction of the Z fiber composite component. Along these lines, the equipment 140, 150 provides precise material handling, positioning and contact pressure (e.g., via robotics), temperature and humidity control (e.g., heating to promote bonding, cooling and drying to promote curing, etc.), cutting to finish layers 180, and so on.

In accordance with certain embodiments, delivery of the different carbon composite materials in alternation continues in order to build up the Z fiber composite component (e.g., illustrated by the arrow 192). The process is complete when the Z fiber composite component has a predefined number of layers 180 or has a predefined height (e.g., as measured along the Z-axis).

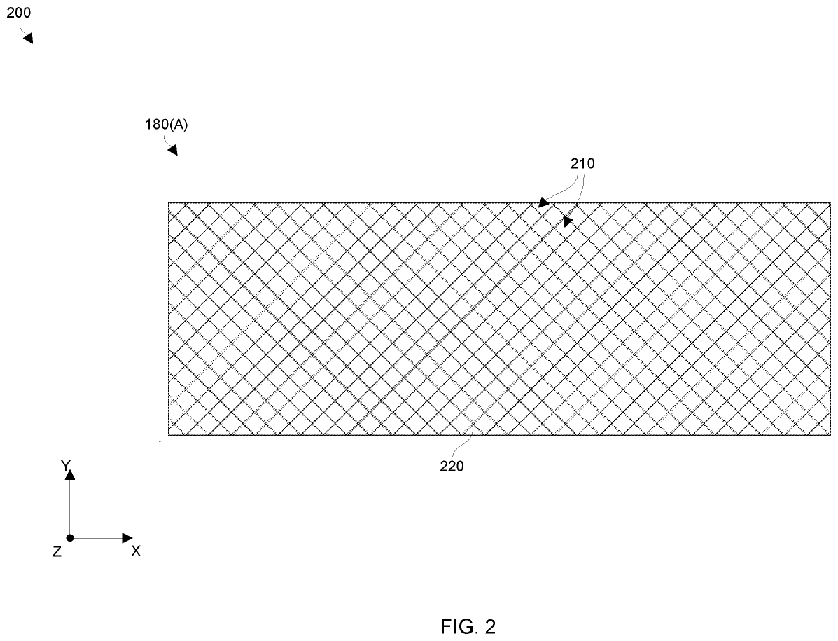

Subsequently, the Z fiber composite component is allowed to cure and may be shaped (e.g., cut, honed, sanded, polished, etc.) and/or further refined. Examples of suitable intermediate and/or end products include heatshields, brake pads, nozzle covers, and the like. Further details will now be provided with reference to FIGS. 2 through 4.

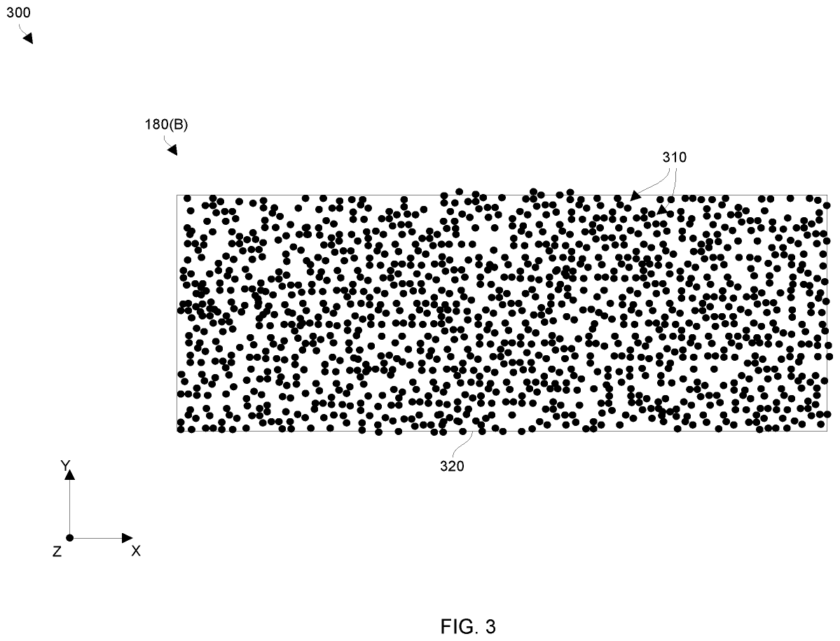

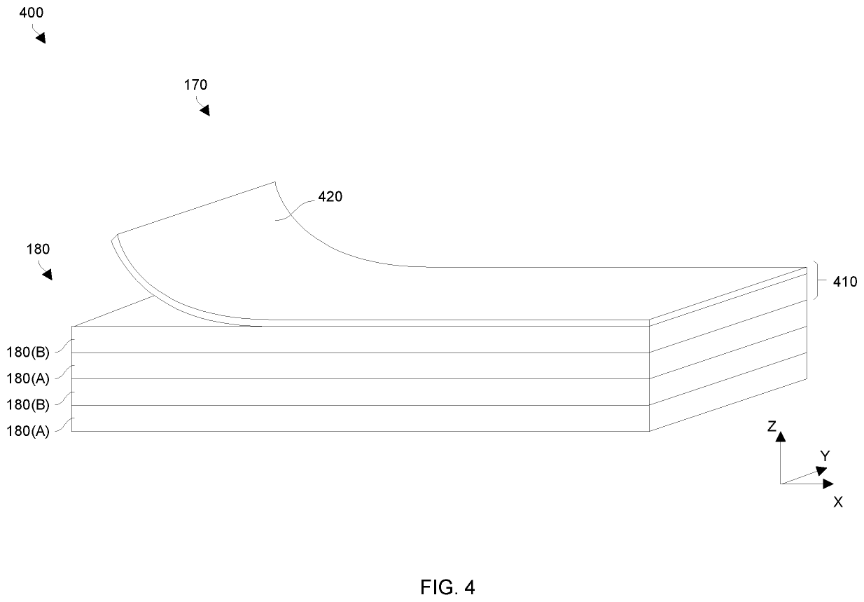

FIGS. 2 through 4 show certain carbon composite material layer details for a Z fiber composite component 170 (FIG. 1) in accordance with certain embodiments. FIG. 2 is a top view 200 of a carbon composite material layer 180(A) which is suitable for Z fiber composite component 170. FIG. 3 is a top view 300 of another carbon composite material layer 180(B) which is suitable for Z fiber composite component 170. FIG. 4 is a cross-sectional view of a Z fiber composite component 170 in accordance with certain embodiments.

As shown by the view 200 in FIG. 2, the carbon composite material layer 180(A) has elongated carbon fibers 210 extending within the X-Y plane. This carbon composite material layer 180(A) is suitable for the layers 180(1) and 180(3) in FIG. 1. In some arrangements, the carbon composite material layer 180(A) is a planar prepreg layer having a carbon matrix with an embedded carbon fiber pattern parallel to the outer surfaces of the planar prepreg layer.

By way of example, the carbon fibers 210 define a bias pattern in which the carbon fibers 210 run at 45 degree angles from the outer edges 220. Such a pattern provides strength in multiple directions within the X-Y plane.

It should be understood that the density (or spacing) of carbon fibers 210 is light in FIG. 2 for illustrations purposes only, and that the actual density of carbon fibers 210 within the layer 180(A) may be significantly higher. Moreover, other carbon fiber patterns are suitable for use as well such as straight-and-cross grain, irregular, etc. as long as the carbon fibers run within the layer 180(A) to provide strength in along the X-Y plane.

As shown by the view 300 in FIG. 3, the carbon composite material layer 180(B) has upright carbon fibers 310 extending in the Z direction, i.e., orthogonal or perpendicular to the X-Y plane. The carbon composite material layer 180(B) may be initially supported by a removable film to preserve integrity prior to use. This carbon composite material layer 180(B) is suitable for the layer 180(2) in FIG. 1.

In some arrangements, the carbon composite material layer 180(B) is a planar prepreg layer having milled carbon fiber segments, the ends of which point outwardly from the surfaces of the planar prepreg layer. Such a carbon fiber pattern provides Z reinforcement when disposed between two carbon composite material layers 180(A) (see FIG. 2). Such upright carbon fibers may have average lengths in the range of 100 to 200 um which may further define the thickness of the layer 180(B) as measured at the edge 320. Again, it should be understood that the density (or spacing) of upright carbon fibers 310 is shown as being relatively light in FIG. 3 for illustrations purposes only, and the actual density of carbon fibers 310 within the layer 180(B) may be significantly higher.

In some arrangements, the carbon composite material layer 180(B) is packaged as a Z tape which includes a removable film (or supporting sheet) and the carbon composite material layer 180(B). For this Z tape, the ends of the upright carbon fibers 310 point into and away from the film as the Z tape is unrolled from a spool. The non-film side of the Z tape is placed in contact with a carbon composite material layer 180(A), and the film on the other side of the Z tape is peeled away to expose that other side for eventual bonding with another carbon composite material layer 180(A).

FIG. 4 shows a partially constructed Z fiber composite component 170 having the carbon composite material layers 180(A) and 180(B) in alternation (also see FIG. 1). Although the Z fiber composite component 170 currently includes four layers 180, it should be understood several more layers 180 may be placed over each other to build up the part even further. Moreover, although FIG. 4 shows the carbon composite material layers 180(A) and 180(B) as generally having the same thicknesses in the Z-direction, the carbon composite material layers 180(A) and 180(B) may have different thicknesses.

As shown in FIG. 4, the layering equipment 140 (FIG. 1) has applied Z tape 410 at the top of the Z fiber composite component 170. Here, the carbon composite material layer 180(B) of the Z tape 410 is placed in contact with an earlier-placed carbon composite material layer 180(A). In some arrangements, the carbon composite material layers 180(B), 180(A) are pressed together with a predetermined amount of force to enable the end of the upright carbon fibers 310 to engage the surface of the carbon composite material layer 180(A) thereunder.

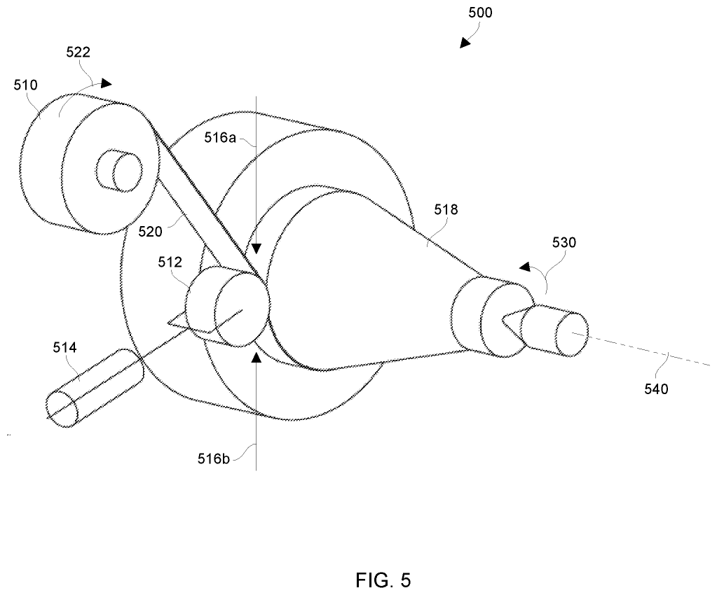

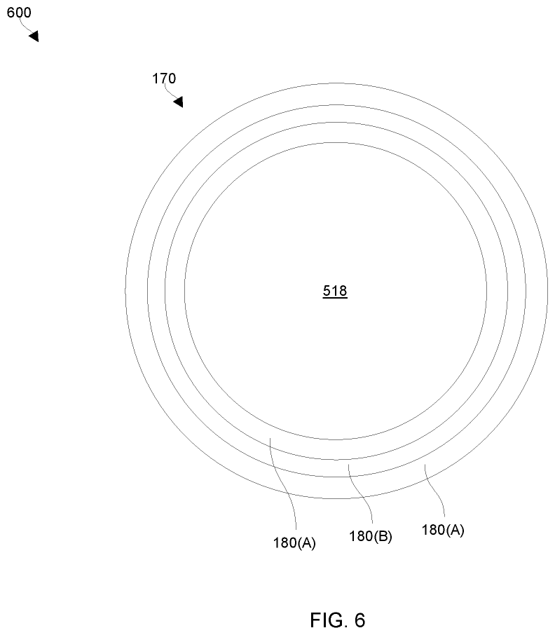

Additionally, a removable film 420 of the Z tape 410 is removed to expose a top surface of the carbon composite material layer 180(B) for further building of the Z fiber composite component 170. Here, the carbon composite material layer 180(B) may itself take the form of a thin film supported by the removable film 420. As mentioned earlier, in accordance with certain embodiments, the removable film 420 of the Z tape 410 maintains the integrity of the carbon composite material layer 180(B) prior to and during placement of the carbon composite material layer 180(B) onto the carbon composite material layer 180(A). Further details will now be provided with reference to FIGS. 5 and 6.

FIGS. 5 and 6 show certain details regarding an automated tape layering (ATL) process that builds a Z fiber composite component 170 in accordance with certain embodiments. FIG. 5 shows certain details of a tape wrapping assembly 500 (also see the apparatus 110 of FIG. 1) when performing part of the ATL process. FIG. 6 shows a cross-sectional view 600 of at least a portion of a Z fiber composite component 170 that is constructed by the ATL process.

As shown in FIG. 5, the tape wrapping assembly 500 is constructed and arranged to apply carbon composite material tape 510 on a horizontal rotating bed. The tape wrapping assembly 500 includes a tape supply 510, a head 512, a set of actuators (or robotics) 514 (depicted as object 514 for simplicity), environmental controls 516a, 516b (illustrated via arrows 516a, 516b), and a mold (or form) 518.

One or more of these components may form at least a portion of the apparatus 110 of FIG. 1. For example, the tape supply 510 is at least part of the set of carbon composite material sources 120. The head 512 and set of actuators 514 are at least part of the layering equipment 140. The environmental controls 516a, 516b are at least part of the other equipment 150, and the mold 518 is at least part of the base 130.

It should be appreciated that the above-identified componentry for the tape wrapping assembly 500 may be more complex than that which is shown in FIG. 5. It should be further appreciated that the componentry may include other equipment/devices (more components, fewer components, different components, etc.) than that which is shown in FIG. 5. For example, the set of actuators/robotics 514 may include one or more arms, effectors/manipulators, other types of actuators/articulators, combinations thereof, and so on.

During operation, an initial tape 520 for the carbon composite material layer 180(A) having carbon fibers extending along the carbon composite layer (e.g., within the plane of the layer) unwinds from the tape supply 510 (also see the carbon composite layer source 120(A) in FIG. 1) in a direction 522. As the tape 520 unwinds, the head 512 of the tape wrapping assembly 500 receives the tape 520 under tension and presses the tape 520 flat toward the mold 518 while the mold 518 rotates in the direction 530 about an axis of rotation 540. Accordingly, the tape 520 winds around a surface of the mold 518. Once the tape wrapping assembly 500 has delivered a full carbon composite material layer 180(A) over the surface of the mold 518, the tape wrapping assembly 500 may cut the tape 520 to complete the layer 180(A).

After the carbon composite material layer 180(A) is fully laid over the surface of the mold 518, the tape supply 510 supplies, as at least part of the tape 520, the carbon composite material layer 180(B) having upright carbon fibers (e.g., across the plane of the layer). Again, the tape 520 (also see the carbon composite layer source 120(B) in FIG. 1) unwinds from the tape supply 510 in a direction 522. As the tape 520 unwinds, the head 512 of the tape wrapping assembly 500 receives the tape 520 under tension and presses the tape 520 flat toward the mold 518 and into the previously placed carbon composite material layer 180(A) while the mold 518 rotates in the direction 530 about the axis of rotation 540. Accordingly, the tape 520 again winds around the mold 518. Once the tape wrapping assembly 500 has delivered a full carbon composite material layer 180(B) over the carbon composite material layer 180(A), the tape wrapping assembly 500 may cut the tape 520 to complete the layer 180(B).

It should be understood that the ends of the upright carbon fibers radially point toward and are pressed into the previously laid carbon composite material layer 180(A) (i.e., the Z direction in FIG. 5). Such engagement of the ends of the upright carbon fibers of the carbon composite material layer 180(b) into the surface of the carbon composite material layer 180(A) improves bonding between the carbon composite material layers 180(A) and 180(B).

As mentioned earlier, the tape 520 for the carbon composite material layer 180(B) having upright carbon fibers may be provided in the form of a Z tape 410 having a film 420 (also see FIG. 4). For the Z tape 410, the carbon composite material layer 180(B) is essentially a film supported by a removable film 420. During application of the carbon composite material layer 180(B), the removable film 420 is peeled from the carbon composite material layer 180(B) to expose an outer surface of the carbon composite material layer 180(B).

Next, the tape supply 510 applies the tape 520 for the carbon composite material layer 180(A) having carbon fibers extending along the carbon composite layer onto the carbon composite material layer 180(B). As the tape wrapping assembly 500 applies the carbon composite material layer 180(A), pressure is applied such that the opposite ends of the upright carbon fibers of the carbon composite material layer 180(B) radially point toward and are pressed into the currently applied carbon composite material layer 180(A). Accordingly, the ends of the upright carbon fibers of the carbon composite material layer 180(B) interact with the surface of the carbon composite material layer 180(A) to improve bonding between the carbon composite material layers 180(A) and 180(B).

It should be understood that this layering process may continue to build up the depth of the Z fiber composite component 170. That is, the tape wrapping assembly 500 may continue to provide the carbon composite material layers 180(A) and 180(B) in alternation.

FIG. 6 shows a cross-section of at least a portion of a Z fiber composite component 170. The Z fiber composite component 170 includes three carbon composite material layers 180(A), 180(B), 180(A).

The carbon composite material layers 180(A) have carbon fibers extending along the carbon composite layers 180(A) and thus around the mold 518. Such carbon composite material layers 180(A) provides planar strength in the directions of the surface that extends around the mold 518.

The carbon composite material layer 180(B) has upright carbon fibers extending radially inward and outward relative to the mold 518. Accordingly, the carbon composite material layer 180(B) provides Z-direction (or radial direction) reinforcement, i.e., improves interlaminar strength. As a result, the Z fiber composite component 170 is resilient in all directions.

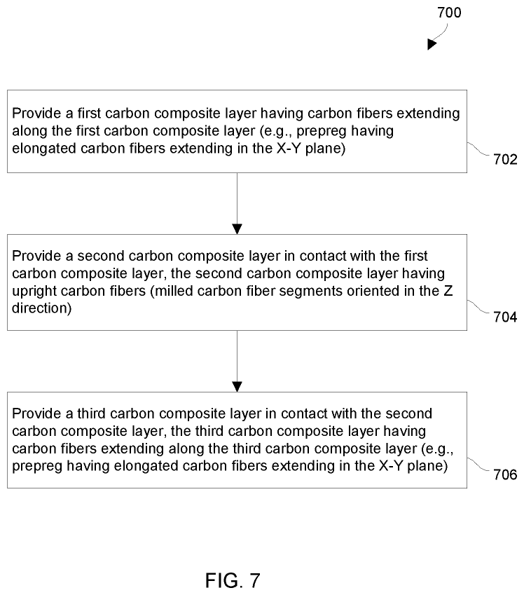

It should be understood that an alternate process for creating the Z fiber composite component 170 involves initially placing sections of the carbon composite material layers 180(A) in a side-by-side (or edge-to-edge) manner to create a larger contiguous surface. Then, sections of the carbon composite material layers 180(B) are placed on top of the sections of the carbon composite material layers 180(A) in a similar side-by-side manner. Next, sections of the carbon composite material layers 180(A) are placed on top of the sections of the carbon composite material layers 180(B) in a similar side-by-side manner. Such a process results in a Z fiber composite component 170 having a surface that extends further than the width of the tape 520 while minimizing switches between the different tapes 520. Further details will now be provided with reference to FIG. 7.

FIG. 7 is a flowchart of a procedure 700 for providing a Z fiber composite component in accordance with certain embodiments. The Z fiber composite component includes carbon composite layers having carbon fibers oriented in different directions resulting in a structure that provides strength in all directions.

At 702, specialized equipment (e.g., also see FIGS. 1 and 5) provides a first carbon composite layer having carbon fibers extending along the first carbon composite layer. Along these lines, the first carbon composite layer may be a prepreg having elongated carbon fibers extending in the X-Y plane (e.g., a layer of 2D carbon/carbon).

At 704, the specialized equipment provides a second carbon composite layer in contact with the first carbon composite layer. The second carbon composite layer has upright carbon fibers (e.g., a layer of Z fibers). Along these lines, the second carbon composite layer may include milled carbon fiber segments.

At 706, the specialized equipment provides a third carbon composite layer in contact with the second carbon composite layer. The third carbon composite layer has carbon fibers extending along the third carbon composite layer. Along these lines, the third carbon composite layer may be a prepreg having elongated carbon fibers extending in the X-Y plane (e.g., another layer of 2D carbon/carbon).

As described above, improved techniques involve providing a structure 170 that includes a carbon composite layer 180(B) having upright carbon fibers between other carbon composite layers 180(A) having carbon fibers extending along the other carbon composite layers (e.g., layers with enhanced X-Y properties). Using a carbon composite layer 180(B) having upright carbon fibers increases the interlaminar strength of the resulting structure. Accordingly, such a structure enjoys Z reinforcement and strength in all dimensions. As a result, there is no need to use additional fasteners or use 3D carbon/carbon.

The various individual features of the particular arrangements, configurations, and embodiments disclosed herein can be combined in any desired manner that makes technological sense. Additionally, such features are hereby combined in this manner to form all possible combinations, variants and permutations except to the extent that such combinations, variants and/or permutations have been expressly excluded or are impractical.

It should be appreciated that some of the improvements relate generally to the field of strategic materials, processes, and systems. Some improvements relate to heatshields (e.g., a conical carbon/carbon hypersonic heatshield with leading edges and control surfaces) and/or similar objects for hypersonic glide vehicles, cruise missiles, and the like. Additionally, some improvements relate to other methods, apparatus, products, articles of manufacture, etc. such as those for manufacturing brake pads, nozzle covers, and so on.

Furthermore, it should be understood that the layers having carbon fibers extending along the layers may have different patterns (e.g., bias, X-direction, Y-direction, straight-and-cross grain, irregular, etc.). For example, with reference to FIG. 1, the layer 180(1) may have a bias carbon fiber pattern, the layer 180(3) may have a straight-and-cross grain carbon fiber pattern, and so on. Such use of different patterns provides different strength properties.

Certain embodiments are directed to techniques involving multi-layer carbon composite material with a milled carbon fiber interlayer. Such techniques may relate to the field of strategic materials and specifically to heatshields for hypersonic glide vehicles and cruise missiles.

In accordance with certain embodiments, a planar, multi-layer carbon/carbon preform includes a plurality of planar prepreg layers each having a carbon matrix with embedded carbon fibers, and a planar interlayer arranged between two adjacent prepreg layers. The interlayer includes an array of short, milled carbon fiber segments extending substantially perpendicularly to a plane of the interlayer and having filament ends pointing into the adjacent prepreg layers.

In a carbon/carbon composite, a carbon matrix may exhibit relatively poor chemical and mechanical bond to reinforcement fibers, so the interlaminar strength of a two-dimensional (2D) carbon/carbon composite may be relatively weak. For this reason, carbon/carbon composites that require isotropic properties, i.e., strength and stiffness in more than just a planar direction, may be manufactured with reinforcement in multiple directions. One exception is conventional carbon/carbon heatshields that are manufactured by using a bias reinforced (i.e., +45 degree) prepreg fabric that is ‘tape wrapped’ using a well-established process. However, in this application, the structural load requirements are handled well with the bias reinforcement, unless a high part thickness results in excessive process-induced radial thermal loads, as is the case with a hypersonic heatshield. Tape wrapped reentry heatshields are typically less than one inch in wall thickness, but for some hypersonic applications, the need arises for a much thicker heatshield, due to a flight duration that is multiple times greater than a reentry heatshield. Similarly, where higher performance carbon/carbon is required, such as in leading edges and control surface components, a multidirectional carbon/carbon is utilized. Because of the complex manufacturing process used to manufacture a multi-dimensional carbon preform, the cost difference between the two forms of carbon/carbon is significant.

In accordance with certain embodiments, a technique uses a layer of short, milled carbon fiber, with a length of between 50 to 300 um for example, placed perpendicularly between the prepreg layers of a 2D carbon/carbon preform, as a method to provide an enhanced 2D cc with significantly increased interlaminar properties (20 to 30%). The milled fiber is preferably provided in a film form and applied between the layers of a carbon/phenolic prepreg with the filament ends pointing into the prepreg. This Z-dimension (perpendicular) reinforcement increases the thickness per ply slightly, and consequently can reduce the X-Y (planar) properties of the composite, since the relative X-Y fiber volumes are reduced with the increased thickness. However, the increased Z properties of the end composite allow for replacement of attached 3D carbon/carbon with thicker walled 2D carbon/carbon.

One example application is a conical carbon/carbon hypersonic heatshield with external features for leading edges and control surfaces. A known approach might involve fabrication of a heatshield with a thick walled 2D tape wrapped area, and machining down some locations for mechanical attachment of 3D c/c for leading edges. In contrast, using the disclosed Z-reinforcement approach, the bulk of the heatshield preform could be fabricated near-net shape, and then the leading-edge areas could be attached directly to the heatshield and molded to shape. After conversion to carbon/carbon, the final structure would be significantly less than the current approach, as the 3D carbon/carbon, the fasteners, and the excessing heatshield thickness areas would be eliminated.

The Z fibers are generally stronger than the carbon matrix between the layers of a 2D carbon/carbon, and consequently increase the interlaminar strength of the composite. They function as a low-cost 3D reinforcement between the layers. The method of using a film of the short Z reinforcement can allow for ease of placement where needed in a very uniform fashion.

In accordance with certain embodiments, there is a structure having an interlayer of milled carbon fiber arranged between adjacent layers of 2D prepreg. Such an arrangement, which has a 2D laminate with a milled-fiber interlayer, is depicted within one or more figures.

It should be understood that conventional processes that incorporate continuous filaments in fabric layers are too difficult or impractical for creating certain products having particular requirements. However, certain improved techniques disclosed herein for applying Z fiber material as a prepreg layer is practical and extensively reduces processing cost. Such Z fiber material may serve as an interlaminar within an otherwise 2D carbon/carbon composite component.

In accordance with certain embodiments, such improved techniques are suitable for use on hypersonic vehicles with thick-walled heatshields, including strategic boost glide vehicles, tactical boost glide vehicles, and hypersonic cruise missiles. Such improved techniques may also be utilized on maneuvering reentry vehicles.

Along these lines, man-rated reentry vehicles and interplanetary vehicles may utilize products formed by the improved techniques. Other carbon/carbon composite products include brakes, oven fixturing, engine components, nozzles, and nosetips.

It should be understood that, in a carbon/carbon composite, as opposed to a polymer matrix/carbon composite, the carbon matrix may exhibit a poor chemical and mechanical bond to the reinforcement fibers. Consequently, the interlaminar strength of a 2D carbon/carbon composite can be relatively weak. For this reason, carbon/carbon composites that require isotropic properties, i.e., strength and stiffness in more than just a planar direction, typically are manufactured with reinforcement in multiple directions.

One exception may be conventional carbon/carbon heatshields that are manufactured by using a bias reinforced (i.e., +45 degree) prepreg fabric that is ‘tape wrapped’ using a well-established process. However, in this application, the structural load requirements are handled fairly well with the bias reinforcement, unless a relatively high part thickness results in excessive process-induced radial thermal loads, as is the case with a hypersonic heatshield. Tape wrapped reentry heatshields are typically less than one inch in wall thickness, but for some hypersonic applications, the need arises for a much thicker heatshield, multiple times greater than a reentry heatshield. Similarly, where higher performance carbon/carbon is required, such as in leading edges and control surface components, a multidirectional carbon/carbon is strongly considered. Because of the complex manufacturing process used to manufacture a multiD carbon preform, the cost difference between the two forms of carbon/carbon is significant.

In accordance with certain embodiments, an improved technique uses a layer of short, milled carbon fiber, with a length of between 100 to 200 um, placed perpendicularly between the prepreg layers of a 2D carbon/carbon preform, as a method to provide an enhanced 2D cc with significantly increased interlaminar properties (20 to 30%). The milled fiber is provided in a film form and can be applied between the layers of a carbon/phenolic prepreg with the filament ends pointing into the prepreg. This Z reinforcement increases the thickness per ply slightly, and consequently may reduce the XY properties of the composite, since the relative XY fiber volumes are reduced with the increased wall thickness. However, the increased Z properties of the end composite allow for replacement of attached 3D carbon/carbon with thicker walled 2D carbon/carbon.

One example is a conical carbon/carbon hypersonic heatshield with external features for leading edges and control surfaces. One current approach would involve fabrication of the heatshield with a thick walled 2D tape wrapped area, and machining down some locations for mechanical attachment of 3D c/c for leading edges. However, with a Z reinforcement process as disclosed herein, the bulk of the heatshield preform may be fabricated near-net shape, and then the leading edge areas may be attached directly to the heatshield and molded to shape. After conversion to carbon/carbon, the final structure can be significantly less than the current approach, as the 3D carbon/carbon, the fasteners, and the excessing heatshield thickness areas would be eliminated.

It should be further understood that the Z fibers are stronger than the carbon matrix between the layers of a 2D carbon/carbon, and consequently increase the interlaminar strength of the composite. They essentially act as a low cost 3D reinforcement between the layers. A method of using a ‘film’ of the short Z reinforcement is new and allows for ease of placement where needed in a very uniform fashion.

Furthermore, it should be understood that additional activities may be included in the above-described processes to control other aspects as well. In accordance with certain embodiments, the processes further include the application of heat (e.g., via a laser, via blown gas, etc.), humidity control, and so on. Moreover, a heatshield may be formed in a controlled amount of time to optimize bonding between layers, curing, cutting, sanding, treating, and so on.

While various embodiments of the invention have been particularly shown and described, it will be understood by those skilled in the art that various changes in form and details may be made therein without departing from the scope of the invention. Support for such combinations, variants and permutations is considered to exist in this document.

What is claimed is:

1. A method of providing a carbon composite component, the method comprising:
providing a first carbon composite layer having carbon fibers extending along the first carbon composite layer;
providing a second carbon composite layer in contact with the first carbon composite layer, the second carbon composite layer having upright carbon fibers; and
providing a third carbon composite layer in contact with the second carbon composite layer, the third carbon composite layer having carbon fibers extending along the third carbon composite layer.

2. A method as in claim 1 wherein providing the first carbon composite layer includes:
depositing, as the first carbon composite layer, a planar prepreg layer having a carbon matrix with an embedded carbon fiber pattern parallel to surfaces of the planar prepreg layer;
wherein the second carbon composite layer includes, as the upright carbon fibers, milled carbon fiber segments; and
wherein providing the second carbon composite layer includes:
placing the second carbon composite layer onto the planar prepreg layer to orient the milled carbon fiber segments in a direction that is toward a surface of the planar prepreg layer.

3. A method as in claim 2 wherein placing the second carbon composite layer onto the planar prepreg layer includes:
applying pressure to press the second carbon composite layer and the planar prepreg layer together to point filament ends of the milled carbon fiber segments of the second carbon composite layer into the planar prepreg layer.

4. A method as in claim 3 wherein providing the third carbon composite layer includes:
placing, as the third carbon composite layer, another planar prepreg layer having a carbon matrix with an embedded carbon fiber pattern parallel to surfaces of the other planar prepreg layer.

5. A method as in claim 4 wherein placing the other planar prepreg layer includes:
applying pressure to press the other planar prepreg layer and the second carbon composite layer together to point other filament ends of the milled carbon fiber segments of the second carbon composite layer into the other planar prepreg layer.

6. A method as in claim 2 wherein providing the second carbon composite layer further includes:
removing a film from the second carbon composite layer, the film being constructed and arranged to maintain integrity of the second carbon composite layer prior to the second carbon composite layer being placed onto the planar prepreg layer.

7. A method as in claim 6 wherein removing the film from the second carbon composite layer includes:
peeling the film from the second carbon composite layer to expose a planar side of the second carbon composite layer.

8. A method as in claim 6 wherein the second carbon composite layer and the film form a Z fiber tape; and
wherein providing the second carbon composite layer further includes:
unrolling the Z fiber tape from a spool as the second carbon composite layer is placed onto the planar prepreg layer.

9. A method as in claim 1, further comprising:
depositing, in alternation over the third carbon composite layer, (i) additional planar prepreg layers, each additional planar prepreg layer having a carbon matrix with an embedded carbon fiber pattern parallel to surfaces of that additional planar prepreg layer and (ii) additional carbon composite layers including upright carbon fiber segments to build a heat resistant structure.

10. A method as in claim 9, further comprising:
forming the heat resistant structure into a heatshield for hypersonic flight.

11. A method as in claim 9, further comprising:
forming the heat resistant structure into a brake pad.

12. A method as in claim 9, further comprising:
forming the heat resistant structure into a nozzle cover for a nozzle.

13. A heat resistant structure formed at least in part by the method of claim 1.

14. Apparatus to provide a carbon composite component, the apparatus comprising:
a set of carbon composite material sources;
a base;
layering equipment constructed and arranged to perform a method of:
providing, from the set of carbon composite material sources on to the base, a first carbon composite layer having carbon fibers extending along the first carbon composite layer,
providing, from the set of carbon composite material sources, a second carbon composite layer in contact with the first carbon composite layer, the second carbon composite layer having upright carbon fibers, and
providing, from the set of carbon composite material sources, a third carbon composite layer in contact with the second carbon composite layer, the third carbon composite layer having carbon fibers extending along the third carbon composite layer.

15. Apparatus as in claim 14 wherein providing the first carbon composite layer includes:
depositing, as the first carbon composite layer, a planar prepreg layer having a carbon matrix with an embedded carbon fiber pattern parallel to surfaces of the planar prepreg layer;
wherein the second carbon composite layer includes, as the upright carbon fibers, milled carbon fiber segments; and
wherein providing the second carbon composite layer includes:
placing the second carbon composite layer onto the planar prepreg layer to orient the milled carbon fiber segments in a direction that is toward a surface of the planar prepreg layer.

16. Apparatus as in claim 15 wherein placing the second carbon composite layer onto the planar prepreg layer includes:
applying pressure to press the second carbon composite layer and the planar prepreg layer together to point filament ends of the milled carbon fiber segments of the second carbon composite layer into the planar prepreg layer.

17. Apparatus as in claim 15 wherein providing the second carbon composite layer further includes:
removing a film from the second carbon composite layer, the film being constructed and arranged to maintain integrity of the second carbon composite layer prior to the second carbon composite layer being placed onto the planar prepreg layer.

18. Apparatus as in claim 15 wherein the method further comprises:
depositing, in alternation above the third carbon composite layer, (i) additional planar prepreg layers, each additional planar prepreg layer having a carbon matrix with an embedded carbon fiber pattern parallel to surfaces of that additional planar prepreg layer and (ii) additional carbon composite layers including upright carbon fiber segments to build a heat resistant structure.
